(19) United States
(12) Patent Application Publication
(10) Pub. No.: US 2024/0289649 A1
(43) Pub. Date: Aug. 29, 2024

(54) SYSTEMS AND METHODS FOR DETECTING AND QUANTIFYING BIAS IN TEXTUAL CONTENT

(71) Applicants: Raj Saha, Wellesley Hills, MA (US); Riya Saha, Wellesley Hills, MA (US)

(72) Inventors: Raj Saha, Wellesley Hills, MA (US); Riya Saha, Wellesley Hills, MA (US)

(21) Appl. No.: 18/588,912

(22) Filed: Feb. 27, 2024

Related U.S. Application Data
(60) Provisional application No. 63/487,358, filed on Feb. 28, 2023.

(51) Int. Cl. G06N 5/022; G06Q 50/10

(52) U.S. Cl. CPC G06N 5/022; G06Q 50/10

(57) ABSTRACT

This disclosure relates to improved techniques for detecting and quantifying bias in textual content, such as textual content included in articles. In certain embodiments, a bias evaluation system is configured to receive an article comprising textual content, analyze the textual content of the article, and generate one or more bias scores indicating or predicting a bias associated with the article. Each of the bias scores generated by the bias evaluation system provides an objective measurement that quantifies the bias included in the article analyzed by the bias evaluation system. The bias scores can be utilized for various purposes. Other embodiments are disclosed herein as well.

### CROSS-REFERENCE TO RELATED APPLICATIONS

This application claims priority to, and the benefit, of U.S. Provisional Patent Application No. 63/487,358 filed on Feb. 28, 2023. The contents of the aforementioned applications are herein incorporated by reference in their entireties.

### TECHNICAL FIELD

This disclosure is related to improved systems, methods, and techniques for detecting and quantifying bias in text corpora. In certain embodiments, the systems, methods, and techniques described herein can be executed to generate bias scores indicating or predicting bias included in textual content, such as news articles and/or other text-based documents.

### BACKGROUND

Journalistic standards and ethics are composed of principles that guide the editing, generation, and publication of articles by media outlets and journalists. Amongst other things, these standards and ethics commonly include principles for publishing articles that comprise unbiased and impartial content. Nevertheless, bias routinely finds its way into published content. In some scenarios, bias may be incorporated unintentionally or incidentally into content that is published and, in other scenarios, bias can be overtly or intentionally incorporated into content to promote a particular point of view on a subject or issue. In some extreme scenarios, content can be intentionally biased to include mischaracterizations or falsehoods. The problems associated with biased content and so-called “fake news” have been brought to the forefront of public attention in recent times.

The problems associated with biased content have impacted many other contexts and environments. In recent times, artificial intelligence (AI) and machine learning models have become common tools for generating content within and across the private and public sectors. For example, the recently launched ChatGPT service from OpenAI® serves as a virtual assistant or chatbot that generates information and content responsive to user prompts or interactions with the system. AI systems also have become prevalent in many other contexts (e.g., in policing to predict recidivism; in healthcare, education and finance as diagnostics and/or decision-making aids; in business contexts to aid in the hiring process).

While these and other types of AI systems provide useful tools, the content or decisions produced by these systems can be biased (e.g., discriminatory, prejudicial, etc.) if the underlying data on which they are trained includes biased content. In many scenarios, the datasets used for training AI systems can incorporate societal inequities and cultural prejudices. In some cases, training datasets may be compiled by aggregating various data points generated by virtue of individuals' day-today activities (e.g., consumer behavior, health conditions, etc.), and these data points may be collected through various platforms. While it is often assumed that data accurately reflects the world, there can be significant data gaps (including little or no data coming from particular communities) and/or data that is replete with bias in racial, economic, gender, age, etc. Additionally, human influence can add to bias in the data (e.g., based on decisions of what, where, and how data is collected and categorized). This all can contribute to bias content being incorporated into training datasets, which, in turn, can result in bias outputs being generated by the AI systems.

### BRIEF DESCRIPTION OF DRAWINGS

To facilitate further description of the embodiments, the following drawings are provided, in which like references are intended to refer to like or corresponding parts, and in which:

FIG. 1A is a diagram of an exemplary system for analyzing bias in articles in accordance with certain embodiments;

FIG. 1B is a block diagram demonstrating exemplary features of an article evaluation platform in accordance with certain embodiments;

FIG. 2 is a flowchart illustrating an exemplary method for predicting or indicating bias in accordance with certain embodiments; and

FIG. 3 is a diagram illustrating an exemplary process flow for remediating bias included in articles in accordance with certain embodiments.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein.

The terms “left,” “right,” “front,” “rear,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

### DETAILED DESCRIPTION OF EXEMPLARY EMBODIMENTS

The present disclosure relates to systems, methods, apparatuses, computer program products, and techniques for detecting and quantifying bias included in articles. In certain embodiments, a bias evaluation system is configured to receive an article comprising textual content, analyze the textual content of the article, and generate one or more bias scores indicating or predicting a bias of the article. The bias scores generated by the bias evaluation system objectively measure and/or quantify the bias included in the articles, and can be utilized for various purposes.

In certain embodiments, the bias evaluation system utilizes multiple evaluation models to analyze each of the articles provided to the bias evaluation system. For example, the bias evaluation system can include a global evaluation model that performs a holistic analysis of content included in an article, a sentence evaluation model that analyzes subjectivity and/or sentimentality in sentences (and/or sentence fragments) in the article, and a word evaluation model that detects occurrences and frequencies of specific bias words included in the content of the article. Each of these of these evaluation models can be configured to generate a separate bias score for the article, and the bias scores can be considered independently and/or combined into a final bias score for the article. Exemplary details relating to each of these evaluation models are described in further detail below.

The bias scores can be utilized by many types of systems and/or applications for various purposes. In some embodiments, the determination that a bias score exceeds a threshold value can trigger one or more actions or functions to be executed by these systems and/or applications. In one example, the bias scores exceeding a threshold can be utilized by news feed applications and/or content filtering systems to trigger actions or functions that remove articles or display warnings to readers. In another example, the scores exceeding a threshold value can be utilized to filter content included in datasets for training AI or machine learning models. The bias scores and/or threshold comparisons can be used for other purposes as well.

Additionally, in certain embodiments, the bias evaluation system also can include a bias correction function that operates to remove or correct bias included in articles. For example, in some cases, the bias correction function can provide recommendations or suggestion for editing content in an article that includes bias language or portions. Additionally, alternatively, the bias correction function can operate to automatically revise biased content included in articles.

As used throughout this disclosure, the term “article” is intended to be utilized broadly and generally can encompass any work that includes textual content. Examples of articles can include content from news media articles, magazine articles, electronic blogs (or posts included thereon), social media content, academic papers, white papers, journal publications, medical or clinical notes (or other documentation relating to patient care), customer reviews of products and/or services, outputs or responses generated by chatbots or AI models (e.g., such as the ChatGPT service offered by OpenAI® and/or other artificial intelligence bots), etc. Additionally, the term article is intended to cover both published and unpublished content.

The technologies described herein provide a variety of benefits and advantages. Amongst other things, the bias scores generated by the bias evaluation system provide objective and quantifiable measurements of bias included in articles, thereby enabling readers or users to understand the level of subjectivity and/or reliability of the articles. Additionally, in some scenarios, these technologies can be used to detect or identify articles that include misinformation or “fake news.” They also can be utilized to analyze content generated by AI models and/or improve datasets utilized to train the AI models. Many additional benefits will be apparent upon reading the disclosure.

The technologies discussed herein can be used in a variety of different contexts and environments. One useful application of these technologies is in the context of analyzing news articles to detect bias and/or information in the articles. In another useful application, these technologies can be incorporated into editing tools used by content generators (e.g., authors, editors, generative AI chatbots or systems, etc.) to detect and remove bias from articles before the articles become published. In another useful application, these technologies can be incorporated into filtering tools that detect and remove articles that include misinformation (and/or that exceed threshold bias levels) from news feeds and/or article databases. In another useful application, these technologies can be utilized to detect bias in clinical or medical notes. In another useful application, these technologies can be utilized to detect bias in responses or outputs of artificial intelligence (AI) chatbots, which can be important because these chatbots are often trained on a text corpus from sources that can include biased content. In another useful application, these technologies can be utilized to detect, identify, and/or correct biased content included in personal forms of communication (e.g., such as e-mails, text messages, instant messaging content, etc.). These technologies can be used in many other contexts as well.

The embodiments described in this disclosure can be combined in various ways. Any aspect or feature that is described for one embodiment can be incorporated to any other embodiment mentioned in this disclosure. Moreover, any of the embodiments described herein may be hardware-based, may be software-based, or, preferably, may comprise a mixture of both hardware and software elements. Thus, while the description herein may describe certain embodiments, features, or components as being implemented in software or hardware, it should be recognized that any embodiment, feature and/or component referenced in this disclosure can be implemented in hardware and/or software.

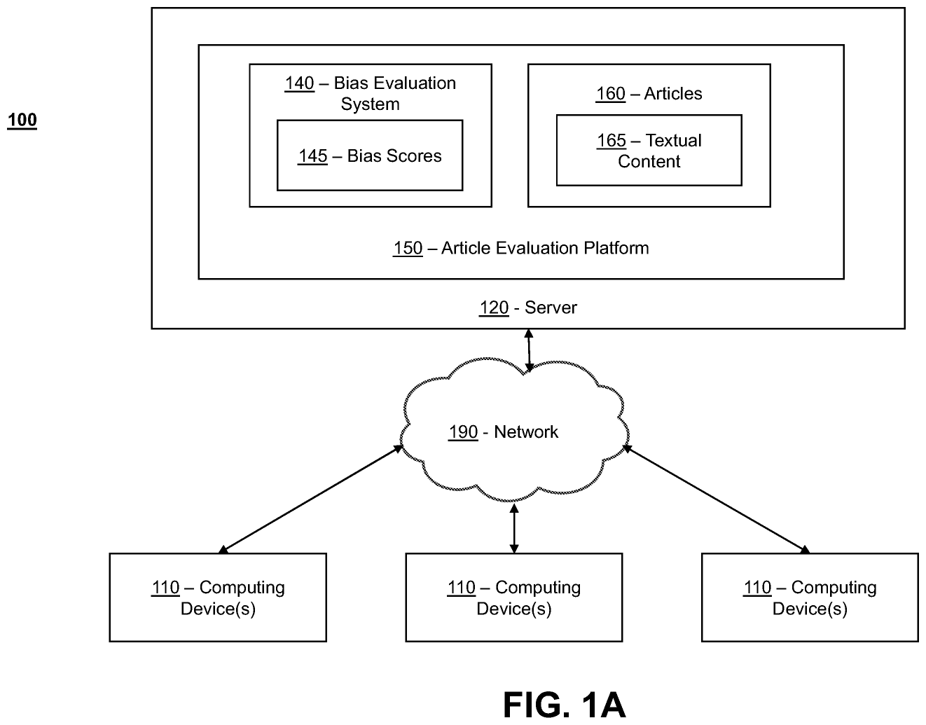

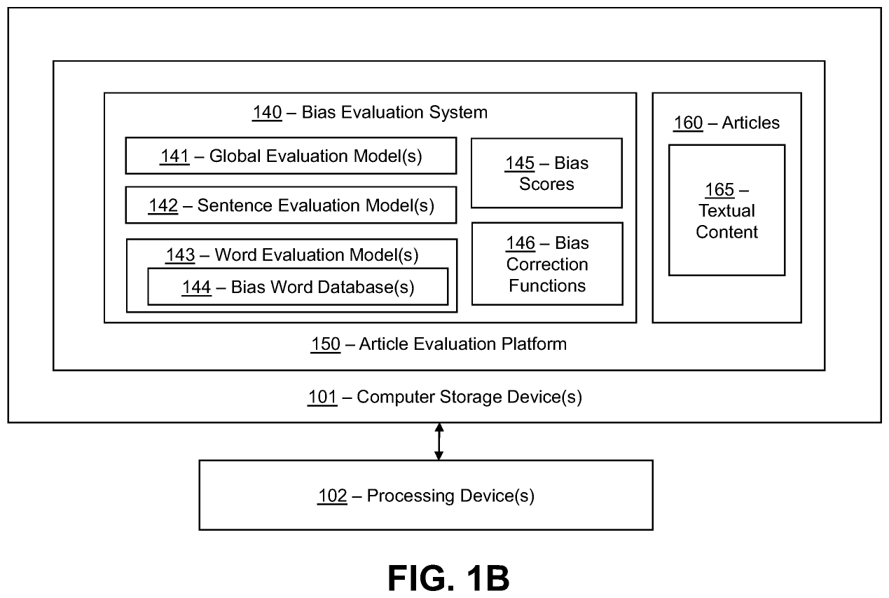

FIG. 1A is a diagram of an exemplary system 100 in accordance with certain embodiments. FIG. 1B is a diagram illustrating exemplary features and/or functions associated with an article evaluation platform 150.

The system 100 comprises one or more computing devices 110 and one or more servers 120 that are in communication over a network 190. An article evaluation platform 150 is stored on, and executed by, the one or more servers 120. As explained in further detail below, the article evaluation platform 150 can include a bias evaluation system 140 that analyzes articles 160 and generates bias scores 145 pertaining to the articles 160. The network 190 may represent any type of communication network, e.g., such as one that comprises a local area network (e.g., a Wi-Fi network), a personal area network (e.g., a Bluetooth network), a wide area network, an intranet, the Internet, a cellular network, a television network, and/or other types of networks.

All the components illustrated in FIG. 1A, including the computing devices 110, servers 120, and article evaluation platform 150 can be configured to communicate directly with each other and/or over the network 190 via wired or wireless communication links, or a combination of the two. Each of the computing devices 110, servers 120, and article evaluation platform 150 can include one or more communication devices, one or more computer storage devices 101, and one or more processing devices 102 that are capable of executing computer program instructions.

The one or more processing devices 102 may include one or more central processing units (CPUs), one or more microprocessors, one or more microcontrollers, one or more controllers, one or more complex instruction set computing (CISC) microprocessors, one or more reduced instruction set computing (RISC) microprocessors, one or more very long instruction word (VLIW) microprocessors, one or more graphics processor units (GPU), one or more digital signal processors, one or more application specific integrated circuits (ASICs), and/or any other type of processor or processing circuit capable of performing desired functions. The one or more processing devices 102 can be configured to execute any computer program instructions that are stored or included on the one or more computer storage devices including, but not limited to, instructions associated the executing and implementing a bias evaluation system 140 that analyzes bias in articles 160.

The one or more computer storage devices 101 may include (i) non-volatile memory, such as, for example, read only memory (ROM) and/or (ii) volatile memory, such as, for example, random access memory (RAM). The non-volatile memory may be removable and/or non-removable non-volatile memory. Meanwhile, RAM may include dynamic RAM (DRAM), static RAM (SRAM), etc. Further, ROM may include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In certain embodiments, the storage devices 101 may be physical, non-transitory mediums. The one or more computer storage devices can store instructions associated with executing and implementing a bias evaluation system 140 that analyzes bias in articles 160.

Each of the one or more communication devices can include wired and wireless communication devices and/or interfaces that enable communications using wired and/or wireless communication techniques. Wired and/or wireless communication can be implemented using any one or combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc. Exemplary LAN and/or WAN protocol(s) can comprise Institute of Electrical and Electronic Engineers (IEEE) 802.3 (also known as Ethernet), IEEE 802.11 (also known as WiFi), etc. Exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware can depend on the network topologies and/or protocols implemented. In certain embodiments, exemplary communication hardware can comprise wired communication hardware including, but not limited to, one or more data buses, one or more universal serial buses (USBs), one or more networking cables (e.g., one or more coaxial cables, optical fiber cables, twisted pair cables, and/or other cables). Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.). In certain embodiments, the one or more communication devices can include one or more transceiver devices, each of which includes a transmitter and a receiver for communicating wirelessly. The one or more communication devices also can include one or more wired ports (e.g., Ethernet ports, USB ports, auxiliary ports, etc.) and related cables and wires (e.g., Ethernet cables, USB cables, auxiliary wires, etc.).

In certain embodiments, the one or more communication devices additionally, or alternatively, can include one or more modem devices, one or more router devices, one or more access points, and/or one or more mobile hot spots. For example, modem devices may enable the computing devices 110, server(s) 120, and/or article evaluation platform 150 to be connected to the Internet and/or other network. The modem devices can permit bi-directional communication between the Internet (and/or other networks) and the computing devices 110, server(s) 120, and/or article evaluation platform 150. In certain embodiments, one or more router devices and/or access points may enable the computing devices 110, server(s) 120, and/or article evaluation platform 150 to be connected to a LAN and/or other more other networks. In certain embodiments, one or more mobile hot spots may be configured to establish a LAN (e.g., a Wi-Fi network) that is linked to another network (e.g., a cellular network). The mobile hot spot may enable the computing devices 110, server(s) 120, and/or article evaluation platform 150 to access the Internet and/or other networks.

In certain embodiments, the computing devices 110 may represent desktop computers, laptop computers, mobile devices (e.g., smart phones, personal digital assistants, tablet devices, vehicular computing devices, wearable devices, or any other device that is mobile in nature), and/or other types of devices. The one or more servers 120 may generally represent any type of computing device, including any of the computing devices 110 mentioned above. The one or more servers 120 also can comprise one or more mainframe computing devices and/or one or more virtual servers that are executed in a cloud-computing environment. In some embodiments, the one or more servers 120 can be configured to execute web servers and can communicate with the computing devices 110, and/or other devices over the network 190 (e.g., over the Internet).

In certain embodiments, the bias evaluation system 140 and/or article evaluation platform 150 can be stored on, and executed by, the one or more servers 120. For example, in some cases, the article evaluation platform 150 may represent a website and/or web-based platform that can be accessed by computing devices 110 to analyze articles 160 provided or identified by users of the computing devices 110. In one example, the bias evaluation system 140 can be implemented as a software-as-a-software (SaaS) platform that is stored on the one or more servers 120, and the data or content associated with the bias evaluation system 140 can be accessed via web browsers and/or one or more application programming interfaces (APIs). Additionally, or alternatively, the bias evaluation system 140 and/or article evaluation platform 150 can be stored on, and executed by, the one or more computing devices 110. The bias evaluation system 140 and/or article evaluation platform 150 can be executed be stored on, and executed, by other devices as well.

In some embodiments, the bias evaluation system 140 and/or article evaluation platform 150 also can be stored as a local application on a computing device 110, or integrated with a local application stored on a computing device 110, to implement the techniques and functions described herein. In certain embodiments, the bias evaluation system 140 and/or article evaluation platform 150 can be integrated with (or can communicate with) various applications including, but not limited to, word processing applications, content publication applications, news feed applications, and/or other applications that are stored on a computing device 110 and/or server 120.

In certain embodiments, the bias evaluation system 140 included on the article evaluation platform 150 is configured to receive the articles 160 comprising textual content 165, analyze the textual content 165 of the articles 160, and generate one or more bias scores 145 for each of the articles 160. Each of the bias scores 145 generated by the bias evaluation system 140 can include a value or indicator that predicts or indicates a level of bias in the articles 160. Exemplary techniques for generating the bias scores 145 are described below.

In some embodiments, the bias evaluation system 140 as can execute bias correction functions 146 that provide assistance with removing detected bias from articles 160. For example, in some cases, the bias correction functions 146 can automatically remove biased content from articles 160 and/or can provide recommendations or suggestions to users for removing biased content from articles 160 (e.g., can suggest alternative words, sentences, phases, etc. that do not include bias). In certain embodiments, the recommendations or suggestions can be generated using a GPT (generative pre-trained transformer) model and/or other generative model that is trained to adapt or modify textual content to remove bias in a manner that preserves the intent of the textual content. The recommendations or suggestions can be generated in other ways as well.

As mentioned above, the articles 160 can broadly encompass any data or work that includes textual content 165 (e.g., words, sentences, paragraphs, titles, etc.). Examples of articles 160 can include content from news media articles, magazine articles, electronic blogs (or posts included thereon), social media content, academic papers, white papers, journal publications, e-mails, instant messaging content, mobile text messages, word processing documents, medical notes, clinical notes, patient documentation, medical systems (e.g., such as products and/or service provided by Epic® or Cerner®), chatbot interactions (e.g., outputs generated by chatbots and/or inputs received by chatbots), AI systems (e.g., generative pre-trained transformer models and/or other content-generating machine learning models), etc. Additionally, the articles 160 are intended to cover both published and unpublished content. Furthermore, the extensiveness of the articles 160 can vary from minimal (e.g., a few sentences or a single paragraph) to lengthy (e.g., hundreds of pages). The articles 160 can be provided in various formats, such as word processing formats, portable document formats (PDFs), web content (e.g., text included on web pages, blogs, etc.), etc. In some cases, the articles 160 can include hard copy documents that are converted to electronic format (e.g., by scanning the documents).

In some embodiments, a user operating a computing device 110 can access the article evaluation platform 150 and identify an article 160 to be analyzed by the bias evaluation. For example, in some scenarios, a user can identify the article 160 by uploading a copy of article 160, specifying a location where the article 160 is stored, providing the article via an API associated with the article evaluation platform 150, and/or specifying a hyperlink or web address where the article 160 is located.

In some embodiments, after an article 160 is identified, the bias evaluation system 140 can perform preprocessing operations on the article 160 to convert the article 160 to a format to be analyzed by the bias evaluation system 140. For example, in some cases, optical character recognition (OCR) may be performed on articles 160 that are stored in certain formats (e.g., PDF formats) and/or hypertext markup language (HTML) tags may be removed from web-based articles 160. Additionally, in some cases, the bias evaluation system 140 may analyze each article to identify different sections (e.g., title, body, etc.) of the article 160, and/or to parse the document on various levels (e.g., to parse the document into separate paragraphs, sentences, and/or words). Other types of preprocessing also can be performed.

After preprocessing operations are performed on an article 160, the bias evaluation system 140 may then execute one or more evaluation models that analyze the content of the article 160 and generate one or more bias scores 145 for the article 160. The types of evaluation models utilized to generate the one or more bias scores 145 can vary.

In certain embodiments, the bias evaluation system 140 utilizes multiple evaluation models to analyze an article 160 provided to the bias evaluation system 140, and each of the models generates a separate bias score 145 for the article 160. For example, in certain embodiments, the bias evaluation system 140 includes a global evaluation model 141, a sentence evaluation model 142, and a word evaluation model 143 as illustrated in FIG. 1B. Each of these models can evaluate an article 160 based on an analysis of different criteria, and each can output a separate bias score 145 for the article 160.

The global evaluation model 141 can be configured to perform a holistic analysis on an article to detect if the article as a whole is directed to factual content or nonfactual content (e.g., or “fake news”) and to generate a corresponding bias score 145. In certain embodiments, the global evaluation model can include naïve Bayes classifier that is pre-trained to output a binary bias score (e.g., 0 or 1) indicating whether an article as a whole is directed to factual or nonfactual content.

During a training phase, the naïve Bayes classifier can be trained in a supervised fashion on a dataset that comprises a subset of articles having real or factual content and another subset of articles having nonfactual or fake content. For each article included in the training dataset, a set of training features can be derived or extracted. The training features for each article can include, inter alia, the title of the article, the text of the article, and a classification label indicating whether the article comprises factual or nonfactual content. In some cases, the training features extracted for each article can be incorporated into a feature vector (or other data structure). The training features (or corresponding feature vector) for each of the articles can then be used to train the naïve Bayes classifier to generate binary bias scores 145 for articles 160 that are analyzed by the classifier. In some embodiments, an interactive, incremental, and/or continuous learning framework can be utilized to improve the bias detection functionality of the classifier.

During an operational phase (e.g., when the classifier is deployed on the article evaluation platform 150), features can be extracted from an article 160 that is being analyzed, including features corresponding to the title and text of the article 160. In some cases, these features can be incorporated into a feature vector. The pre-trained naïve Bayes classifier can utilize the features (or the corresponding feature vector) to predict a binary bias score 345 (e.g., 0 or 1) for the article being analyzed.

The sentence evaluation model 142 can output a second bias score 145 for an article 160 that is analyzed by the bias evaluation system 140. In certain embodiments, the sentence evaluation model 142 can include a sentiment analysis function that generates a separate subjectivity score for each sentence include in the textual content 165 of an article 160. These subjectivity scores for the sentences can then be combined, or jointly considered, to generate the second bias score 145 for the article 160. In some exemplary scenarios, each of the subjectivity scores can represent a value between zero and one, and the subjectivity scores can be combined by averaging the scores to determine the second bias score 145 for the article 160. The second bias score 145 can be determined in other ways as well.

In certain embodiments, the sentence evaluation model 142 include, or communicate with, a pre-trained language model that is configured to perform various natural language processing (NLP) tasks to generate the subjectivity scores including, but not limited to, NLP tasks for sentiment analysis, text classification, and/or speech tagging. The language model can be configured to analyze a vector or feature embedding derived from a given sentence (or fragment thereof) to determine the subjectivity scores. In some examples, the sentence evaluation model 142 or language model can be provided by a third-party service, such as TextBlob, that includes an application programming interface (API) configured to receive queries from users. Each article 160, or each sentence included in an article 160, can be submitted via the API to obtain the aforementioned subjectivity scores utilized to generate the second bias score 145.

A word evaluation model 143 can output a third bias score 145 for an article 160 that is analyzed by the bias evaluation system 140. In certain embodiments, the word evaluation model 143 can analyze the article 160 on a more granular level (at the word level) to assess bias in the article 160.

The word evaluation model 143 can include or communicate with a bias word database 144 that comprises a compilation of predetermined or pre-identified bias words (e.g., words commonly denoting or representative of bias, prejudice, and/or subjectivity). Prior analyses of language bias indicate distinct categories of bias or prejudice. These categories can include, but are not limited to: gender, age, race, disability, LGBTQ, ethnicity, former felons, elitism, mental health, and/or religion. In certain embodiments, the bias word database 144 can include and store a listing of words for each of the aforementioned categories and/or other categories related to bias or prejudice.

In certain embodiments, the words included in the bias word database 144 can be segregated into separate domain-specific datasets, each of which can be useful for identifying bias in specific use cases. For example, one domain-specific dataset can include words that commonly denote bias in medical documentations (e.g., clinical notes). Another exemplary domain-specific dataset can include words commonly denoting bias is legal documents. Another exemplary domain-specific dataset can include general prejudice words (e.g., denoting prejudice based on sex, race, ethnicity, etc.). Another exemplary domain-specific dataset can include words commonly bias in customer reviews of products and/or service. These and other types of domain-specific datasets can be utilized in various use cases or applications (e.g., to analyze medical documentation, legal documentations, customer reviews, news articles, etc.). Using domain-specific datasets for specific use cases or applications (e.g., using a domain-specific data set for medical documentation to analyze articles pertaining to clinical notes) can improve the bias scores 145 that are generated by the bias evaluation system 140.

The word evaluation model 143 can search the textual content 165 of an article 160 for the existence and frequency of each word included in the bias word database 144. An analysis function or equation can utilize the existence and frequencies of the detected bias words to derive the third bias score 145 for the article. For example, in some cases, the analysis function or equation can output a value on a scale from 0 to 1 that provides a bias indicator based on the detected bias words and their frequencies, and this value can be utilized as the third bias score 145. The third bias score 145 can be determined in other ways as well.

As described above, the bias evaluation system 140 can generate at least three bias scores 145 for each article 160 that is analyzed including: a) a first bias 145 derived from a holistic review of the document and relating to the factual/nonfactual nature of the article 160; b) a second bias second 145 derived from an analysis of the subjectivity and/or sentimentality of each sentence included in the article 160; and c) a third bias score 145 derived from an analysis of individuals words that are identified by a bias word database 144. In some embodiments, the bias evaluation system 140 can output each of these bias scores 145 to indicate or predict the bias in a given article 160. Additionally, or alternatively, the bias evaluation system 140 can generate or derive a global bias score 145 that is derived from the three individual bias scores 145. For example, in some cases, the three bias scores 145 can be received as inputs to a weighted combination function that generates a global bias score 145 based on their values.

In certain embodiments, an optimization phase can be applied to enhance the accuracy of the bias scores 145 generated by the bias evaluation system 140. For example, after the global evaluation model 141, sentence evaluation 142, and word evaluation model 143 have been created or initialized, various articles 160 (e.g., news media articles) can be manually tagged or annotated with bias scores 145 (e.g., each of the three bias scores 145 described mentioned above). The labeled articles 160 can then be provided to a machine learning optimization function that iteratively adjusts the weights associated with each of the sub-models (i.e., the global evaluation model 141, sentence evaluation 142, and word evaluation model 143) to enhance the accuracy of the bias scores 145.

In certain embodiments, the bias scores 145 generated by the bias evaluation system 140 can be displayed to users on one or more computing devices 110. For example, in some cases, the computing devices 110 can enable users to view and/or access the bias scores 145 generated by the bias evaluation system 140 over the network 190 (e.g., over the Internet via a web browser application). In other cases, the computing devices 110 themselves may execute the bias evaluation system 140 and the bias scores 145 can be viewed or accessed directly on the computing devices 110.

The bias scores 145 can be utilized for various purposes. In some scenarios, the bias score 145 can help readers understand a level bias in news articles, clinical notes, legal documents, and/or other types of articles. In other scenarios, the bias scores 145 can be provided to editing tools used by content generators (e.g., authors, editors, etc.) to allow the content generators to detect and remove bias from articles before the articles become published. In other scenarios, the bias scores can be utilized to identify biased content in personal communications (e.g., e-mails, text messages, etc.). In other scenarios, the bias scores 145 can be used to analyze outputs or responses of chatbots and/or other AI content generating functions (and to refine the underlying machine learning models). In other scenarios, the bias scores can be utilized by news feeds or content filters to detect and remove articles that include misinformation (and/or that exceed threshold bias levels). In some embodiments, the bias scores 145 can be compared to a threshold to trigger execution of actions by one or more applications or systems (e.g., to delete or remove articles, provide warnings to readers, filter content, etc.). These technologies can be used in many other contexts as well.

Additionally, the analysis of an article 160 by the bias evaluation system 140 can enable biased content to be corrected and/or removed from the article 160 using the bias correction functions 146. The bias correction functions 146 can be executed in real-time such that bias content is identified while an article 160 is being created. In this example, the bias correction functions 146 may flag biased content and present alternative non-biased content (e.g., alternative words or phrases) to replace the biased content while the article 160 is being generated by a user. Additionally, or alternatively, the bias correction functions 146 can operate on articles 160 that have already been created, and can remove biased content and/or propose changes to biased content in the article 160.

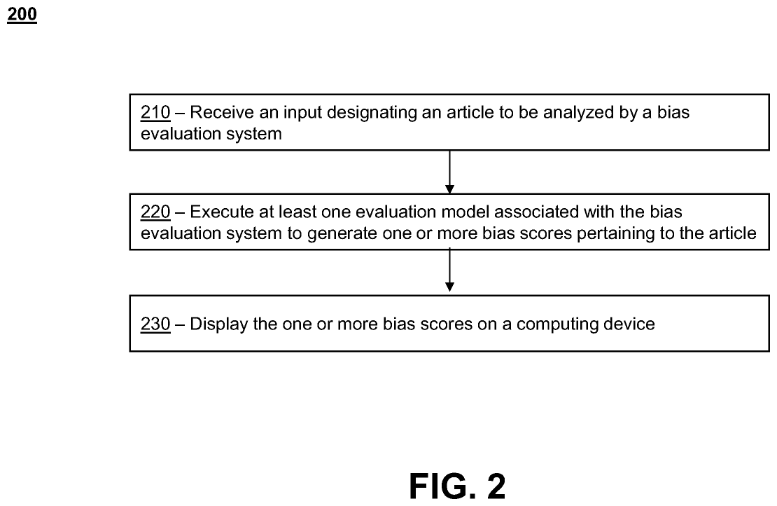

FIG. 2 illustrates a flow chart for an exemplary method 200 according to certain embodiments. Method 200 is merely exemplary and is not limited to the embodiments presented herein. Method 200 can be employed in many different embodiments or examples not specifically depicted or described herein. In some embodiments, the steps of method 200 can be performed in the order presented. In other embodiments, the activities of method 200 can be performed in any suitable order. In still other embodiments, one or more of the steps of method 200 can be combined or skipped. In many embodiments, system 100, bias evaluation system 140, and/or article evaluation platform 150 can be configured to perform method 200 and/or one or more of the steps of method 200. In these or other embodiments, one or more of the steps of method 200 can be implemented as one or more computer instructions configured to run at one or more processing devices 201 and configured to be stored at one or more non-transitory computer storage devices 101. Such non-transitory memory storage devices 101 can be part of a computer system such as system 100, bias evaluation system 140, and/or article evaluation platform 150. The processing device(s) 102 can be similar or identical to the processing device(s) 102 described above with respect to system 100 and/or article evaluation platform 150.

In step 210, an input designating an article 160 to be analyzed by a bias evaluation system 140 is received. For example, the input may include a file location, hyperlink, or other identifier that identifies a location of the article 160.

In step 220, at least one evaluation model associated with the bias evaluation system 140 is executed to generate one or more bias scores 145 pertaining to the article 160. In certain embodiments, three separate evaluation models (e.g., the global evaluation model 141, sentence evaluation 142, and word evaluation model 143) are executed, and each generates a separate bias score 145 for the article 160 as described above.

In step 230, the one or more bias scores 145 are displayed on a computing device 110 for display. For example, in some scenarios, the one or more bias scores 145 can be transmitted over a network 190 from a server 120 to the computing device 110. In other scenarios, the one or more bias scores 145 can be generated by the computing device 110 and displayed on the computing device 110.

Additionally, or alternatively, the one or more bias scores 145 can be utilized to trigger execution of actions or functions for particular types of systems and/or applications. In some embodiments, the bias score 145 can be compared to threshold and, if the bias score 145 exceeds the threshold, this can trigger one or more actions or functions to be executed a system or application. For example, the detection of a bias score 145 exceeding a threshold can be utilized by news feed and/or filtering applications to remove, modify, or flag news articles. Likewise, the detection of a bias score 145 exceeding a threshold can be utilized by an AI system to refine outputs generated by machine learning models (e.g., AI chatbots) and/or to refine datasets utilized to train such models. The bias scores and/or threshold comparisons can be used for other use cases as well.

In some cases, method 200 can be supplemented with an additional step of executing a bias correction function 146 to assist with removing biased content from the article 160. In some cases, this can include automatically removing or modifying biased content, and/or providing recommendations to remove or modify biased content in the article 160.

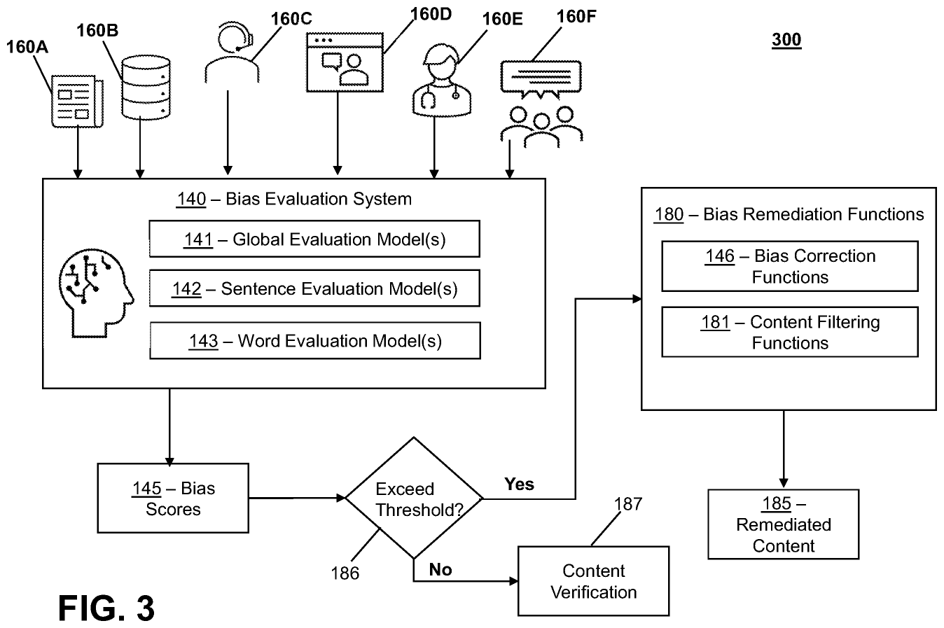

FIG. 3 is a diagram illustrating an exemplary process flow 300 for remediating bias included in articles 160 according to certain embodiments. As illustrated, the bias evaluation system 140 can receive various types of articles 160 including, but not limited, to news articles 160A (e.g., articles included in newspapers, magazines, online blogs, etc.), training datasets 160B (e.g., comprising a collection of textual content for training an AI or machine-learning model), AI chatbot outputs 160C (e.g., textual content output by GPT models and/or other generative models), social media content 160D (e.g., textual content or posts on social media sites), and/or medical documentation 160E (e.g., textual content from medical notes, medical records, etc.). Many other types of articles 160 can be received and analyzed by the bias evaluation system 140. Each of the articles 160 can correspond to electronic files or data that include textual content 165.

For each article 160, the bias evaluation system 140 can generate at least one bias score 145 corresponding to the article 160. As described above, the bias evaluation system 140 can include a global evaluation model 141, a sentence evaluation model 142, and a word evaluation model 143 that analyze the articles 160 and generate outputs for determining one or more bias scores 145 corresponding to the articles 160.

At decision block 186, the bias score 145 for a corresponding article 160 is compared to threshold. If the bias score 145 does not exceed the threshold, the article 160 is verified (block 187) as not including bias content and/or having a sufficiently low level of biased content. Conversely, if the bias score 145 exceeds the threshold, one or more remediation functions 180 can be executed.

The remediation functions 180 can generally correspond to any function that operates to highlight, identify, modify, adapt, edit, and/or delete textual content 165 that is determined to be biased, and/or operates to modify, alter, or exclude articles 160 that are determined to include biased content. In some examples, executing a remediation function 180 can include executing a bias correction function 146 that operates to remove detected bias from the article 160, highlight or flag biased content in the article 160, and/or provide proposed recommendations for removing or changing the biased content. In some cases, the bias correction function 146 can generate or output remediated content 185, which include a modified version of the article 160 with the biased content in the article 160 being removed or changed.

In other examples, executing a remediation function 180 can include executing a content filtering function 181 that filters the article 160 (or biased content included in the textual content 165 of the article 160) from a data feed or dataset. In some scenarios, the content filtering function 181 can cause the article 160 (or biased content therein) to be excluded or removed from a data feed (e.g., a data feed that is updated continuously and/or in real-time). In other scenarios, the content filtering function 181 can prevent the article 160 (or biased content therein) from being included in a dataset (e.g., a model training dataset 160B that is utilized to train an AI or machine-learning model).

Many other types of remediation functions 180 can be executed in response to detecting that an article 160 exceeds a threshold level of biased content.

As evidenced by the disclosure herein, the inventive techniques set forth in this disclosure are rooted in computer technologies that overcome existing problems in known evaluating textual content for bias. The techniques described in this disclosure provide a technical solution (e.g., one that utilizes machine learning models and techniques) for overcoming the limitations associated with known techniques for assessing and/or correcting biased content. This technology-based solution marks an improvement over existing capabilities and functionalities related to detecting and quantifying bias in textual content by combining outputs from multiple evaluation models that analyze a given article a from varying scopes (e.g., form a holistic, sentence, and word scope).

In certain embodiments, a system is provided. The system comprises one or more computing devices comprising one or more processing devices and one or more non-transitory storage devices that store instructions. Execution of the instructions by the one or more processing devices causes the one or more computing devices to: receive, by a bias evaluation system, an article comprising textual content; execute at least one evaluation model associated with the bias evaluation system to generate one or more bias scores corresponding to the article, wherein each of the one or more bias scores measure or quantify bias included in the textual content of the article; and output, by the bias evaluation system, the one or more bias scores.

In certain embodiments, a method is implemented via execution of computing instructions configured to run at one or more processing devices and configured to be stored on non-transitory computer-readable media. The method comprises: receive, by a bias evaluation system, an article comprising textual content; execute at least one evaluation model associated with the bias evaluation system to generate one or more bias scores corresponding to the article, wherein each of the one or more bias scores measure or quantify bias included in the textual content of the article; and output, by the bias evaluation system, the one or more bias scores.

In certain embodiments, a computer program product is provided. The computer program product comprises a non-transitory computer-readable medium including instructions for causing a computing device to: receive, by a bias evaluation system, an article comprising textual content; execute at least one evaluation model associated with the bias evaluation system to generate one or more bias scores corresponding to the article, wherein each of the one or more bias scores measure or quantify bias included in the textual content of the article; and output, by the bias evaluation system, the one or more bias scores.

Embodiments may include a computer program product accessible from a computer-usable or computer-readable medium providing program code for use by or in connection with a computer or any instruction execution system. A computer-usable or computer-readable medium may include any apparatus that stores, communicates, propagates, or transports the program for use by or in connection with the instruction execution system, apparatus, or device. The medium can be a magnetic, optical, electronic, electromagnetic, infrared, or semiconductor system (or apparatus or device) or a propagation medium. The medium may include a computer-readable storage medium, such as a semiconductor or solid-state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

It should be recognized that any features and/or functionalities described for an embodiment in this application can be incorporated into any other embodiment mentioned in this disclosure. Moreover, the embodiments described in this disclosure can be combined in various ways. Additionally, while the description herein may describe certain embodiments, features, or components as being implemented in software or hardware, it should be recognized that any embodiment, feature, or component that is described in the present application may be implemented in hardware, software, or a combination of the two.

While various novel features of the invention have been shown, described, and pointed out as applied to particular embodiments thereof, it should be understood that various omissions and substitutions, and changes in the form and details of the systems and methods described and illustrated, may be made by those skilled in the art without departing from the spirit of the invention. Amongst other things, the steps in the methods may be carried out in different orders in many cases where such may be appropriate. Those skilled in the art will recognize, based on the above disclosure and an understanding of the teachings of the invention, that the particular hardware and devices that are part of the system described herein, and the general functionality provided by and incorporated therein, may vary in different embodiments of the invention. Accordingly, the description of system components is for illustrative purposes to facilitate a full and complete understanding and appreciation of the various aspects and functionality of particular embodiments of the invention as realized in system and method embodiments thereof. Those skilled in the art will appreciate that the invention can be practiced in other than the described embodiments, which are presented for purposes of illustration and not limitation. Variations, modifications, and other implementations of what is described herein may occur to those of ordinary skill in the art without departing from the spirit and scope of the present invention and its claims.

1. A system of one or more computing devices comprising one or more processing devices and one or more non-transitory storage devices that store instructions, wherein execution of the instructions by the one or more processing devices causes the one or more computing devices to:
receive, by a bias evaluation system, an article comprising textual content;
execute at least one evaluation model associated with the bias evaluation system to generate one or more bias scores corresponding to the article, wherein each of the one or more bias scores measure or quantify bias included in the textual content of the article; and
output, by the bias evaluation system, the one or more bias scores.

2. The system of claim 1, wherein the at least one evaluation model comprises:
a global evaluation model configured to generate a first bias score based on a holistic analysis of the textual content included in the article;
a sentence evaluation model configured to generate a second bias score by measuring subjectivity or sentimentality in sentences or sentence fragments included in the article; and
a word evaluation model configured to generate a third bias score by detecting occurrences and frequencies of predetermined bias words included in the textual content of the article.

3. The system of claim 2, wherein:
the global evaluation model includes a classifier that is pre-trained to output a binary bias score predicting whether the article as a whole is directed to factual or nonfactual content, and the classifier utilizes a feature vector derived from the article to predict the binary bias score;
the binary bias score generated by the global evaluation model is utilized to derive the first bias score;
the sentence evaluation model comprises a language model that is pre-trained to perform sentiment analysis functions on the textual content of the article and generate one or more subjectivity scores for each of the sentences or each of the sentence fragments included in the textual content of an article;
the one or more subjectivity scores generated by the sentence evaluation model are utilized to derive the second bias score; and
the word evaluation model accesses a bias word database that stores a compilation of the predetermined bias words, analyzes the textual content of the article to detect whether one or more of the predetermined bias words are included within the textual content of the article, and generates the third bias score based on said analysis of the textual content.

4. The system of claim 3, wherein a final bias score is computed by combining the first bias score generated by the global evaluation model, the second bias score generated by the sentence evaluation model, and the third bias score generated by the word evaluation model.

5. The system of claim 1, wherein the one or more bias scores are utilized by a content filtering function that is configured to filter the or exclude access to the article based on a determination that the article comprises an unacceptable level of bias.

6. The system of claim 5, wherein the article corresponds to news article and the content filtering function is adapted to filter the news article from a news feed in response to determining the one or more bias scores exceed a bias threshold.

7. The system of claim 5, wherein:
the article comprises textual content associated with a training dataset for training a learning model; and
the content filtering function removes or excludes the article from the training dataset in response to determining that the one or more bias scores exceed a bias threshold.

8. The system of claim 1, wherein execution of the instructions further causes the one or more processing devices to execute a bias correction function that is configured to: a) automatically remove or correct textual content in the article determined to be biased; or b) generate recommendations or suggestions for modifying the textual content in the article determined to be biased.

9. A method implemented via execution of computing instructions configured to run at one or more processing devices and configured to be stored on non-transitory computer-readable media, the method comprising:
receiving, by a bias evaluation system, an article comprising textual content;
executing at least one evaluation model associated with the bias evaluation system to generate one or more bias scores corresponding to the article, wherein each of the one or more bias scores measure or quantify bias included in the textual content of the article; and
outputting, by the bias evaluation system, the one or more bias scores.

10. The method of claim 9, wherein the at least one evaluation model comprises:
a global evaluation model is configured to generate a first bias score based on a holistic analysis of the textual content included in the article;
a sentence evaluation model configured to generate a second bias score by measuring subjectivity or sentimentality in sentences or sentence fragments included in the article; and
a word evaluation model configured to generate a third bias score by detecting occurrences and frequencies of predetermined bias words included in the textual content of the article.

11. The method of claim 10, wherein:
the global evaluation model includes a classifier that is pre-trained to output a binary bias score predicting whether the article as a whole is directed to factual or nonfactual content, and the classifier utilizes a feature vector derived from the article to predict the binary bias score;
the binary bias score generated by the global evaluation model is utilized to derive the first bias score;
the sentence evaluation model comprises a language model that is pre-trained to perform sentiment analysis functions on the textual content of the article and generate one or more subjectivity scores for each of the sentences or each of the sentence fragments included in the textual content of an article;
the one or more subjectivity scores generated by the sentence evaluation model are utilized to derive the second bias score; and
the word evaluation model accesses a bias word database that stores a compilation of the predetermined bias words, analyzes the textual content of the article to detect whether one or more of the predetermined bias words are included within the textual content of the article, and generates the third bias score based on said analysis of the textual content.

12. The method of claim 11, wherein a final bias score is computed by combining the first bias score generated by the global evaluation model, the second bias score generated by the sentence evaluation model, and the third bias score generated by the word evaluation model.

13. The method of claim 9, wherein the one or more bias scores are utilized by a content filtering function that is configured to filter the or exclude access to the article based on a determination that the article comprises an unacceptable level of bias.

14. The method of claim 13, wherein the article corresponds to news article and the content filtering function is adapted to filter the news article from a news feed in response to determining the one or more bias scores exceed a bias threshold.

15. The method of claim 13, wherein:
the article comprises textual content associated with a training dataset for training a learning model; and
the content filtering function removes or excludes the article from the training dataset in response to determining that the one or more bias scores exceed a bias threshold.

16. The method of claim 9, wherein execution of the instructions further causes the one or more processing devices to execute a bias correction function that is configured to: a) automatically remove or correct textual content in the article determined to be biased; or b) generate recommendations or suggestions for modifying the textual content in the article determined to be biased.

17. A computer program product, the computer program product comprising a non-transitory computer-readable medium including instructions for causing a computing device to:
receive, by a bias evaluation system, an article comprising textual content;
execute at least one evaluation model associated with the bias evaluation system to generate one or more bias scores corresponding to the article; and
output, by the bias evaluation system, the one or more bias scores.

18. The computer program product of claim 17, wherein the at least one evaluation model comprises:
a global evaluation model configured to generate a first bias score based on a holistic analysis of the textual content included in the article;
a sentence evaluation model configured to generate a second bias score by measuring subjectivity or sentimentality in sentences or sentence fragments included in the article, wherein each of the one or more bias scores measure or quantify bias included in the textual content of the article; and
a word evaluation model configured to generate a third bias score by detecting occurrences and frequencies of predetermined bias words included in the textual content of the article.

19. The computer program product of claim 18, wherein:
the global evaluation model includes a classifier that is pre-trained to output a binary bias score predicting whether the article as a whole is directed to factual or nonfactual content, and the classifier utilizes a feature vector derived from the article to predict the binary bias score;
the binary bias score generated by the global evaluation model is utilized to derive the first bias score;
the sentence evaluation model comprises a language model that is pre-trained to perform sentiment analysis functions on the textual content of the article and generate one or more subjectivity scores for each of the sentences or each of the sentence fragments included in the textual content of an article;
the one or more subjectivity scores generated by the sentence evaluation model are utilized to derive the second bias score; and
the word evaluation model accesses a bias word database that stores a compilation of the predetermined bias words, analyzes the textual content of the article to detect whether one or more of the predetermined bias words are included within the textual content of the article, and generates the third bias score based on said analysis of the textual content.

20. The computer program product of claim 19, wherein a final bias score is computed by combining the first bias score generated by the global evaluation model, the second bias score generated by the sentence evaluation model, and the third bias score generated by the word evaluation model.
